(19) United States
(12) Patent Application Publication
(10) Pub. No.: US 2008/0079583 A1
(43) Pub. Date: Apr. 3, 2008

(54) Radio frequency analyzer/diagnostic tool and method

(75) Inventors: Mark Alexis, Wellington, FL (US); Gary Mark Shafer, Boca Raton, FL (US); Robert Kevin Lynch, Greenacres, FL (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: Sensormatic Electronics Corporation;

(21) Appl. No.: 11/796,188

(22) Filed: Apr. 27, 2007

Related U.S. Application Data
(60) Provisional application No. 60/848,221, filed on Sep. 29, 2006.

(51) Int. Cl. G08B 13/14

(52) U.S. Cl. 340/572.1

(57) ABSTRACT

A method, device and system for radio frequency identification (“RFID”) performance analysis. An analyzer for analyzing the performance of an RFID reader is provided. The analyzer has an interface in communication with the reader. A processor is in communication with the interface. The processor operates to use the interface to monitor communication with the reader and/or simulate one or more RFID tags.

### CROSS-REFERENCE TO RELATED APPLICATION

This application is related to and claims priority to U.S. Provisional Patent Application Ser. No. 60/848,221, filed Sep. 29, 2006, entitled RADIO FREQUENCY ANALYZER/DIAGNOSTIC TOOL AND METHOD, the entirety of which is incorporated herein by reference.

### STATEMENT REGARDING FEDERALLY SPONSORED RESEARCH OR DEVELOPMENT

n/a

### FIELD OF THE INVENTION

The present invention relates to radio frequency communications and in particular to a device and method for analyzing and diagnosing radio frequency identification (“RFID”) systems.

### BACKGROUND OF THE INVENTION

RFID systems are used in many different applications, including for example in retail environments, to obtain information relating to items tagged with RFID identifiers. For example, an RFID tag can be attached or integrated within a product or product packaging. Using an RFID interrogator (also referred to herein as an “RFID reader”), which may be a fixed, portable or handheld device, RFID tags within the interrogation zone of the interrogator may be activated and provide information regarding the item associated with the RFID tag (e.g., product descriptor, serial number, location, etc.). These RFID tags receive and respond to radio frequency (“RF”) signals to provide information, for example, related to the product to which the RFID tag is attached. This is typically accomplished using a standard air interface protocol such as the Electronic Product Code (“EPC”) Radio Frequency Identity Protocol. Such information may include inventory information relating to items on a shelf or items in a warehouse. In general, modulators within the RFID tags may transmit back a signal using a transmitter or reflect back a signal to the RFID readers. This transmitted/reflected signal is referred to as a backscatter signal. Additionally, information may be communicated to the RFID tags (e.g., encoding information) using RFID encoders. Thus, RFID systems are typically used to monitor the inventory of products in a retail environment and provide product identification using the storage and remote retrieval of data using RFID tags or transponders.

The increasing use of RFID necessitates a way to effectively analyze RFID systems, for example to isolate problems, determine system capacities and the like. Engineers currently have no good way to decode commands from an RFID reader and store them for future analysis or to use as the commands as a trigger for the capture of some other aspect of communication to/from the reader. It is therefore desirable to have a device that can be used as a diagnostic and/or lab tool to capture and decode RFID reader transmissions and/or responses from a tag to the reader.

In addition, when developing new RFID components, such as new readers, simulation equipment is useful in the lab to test and debug the equipment. For example, it is desirable to have a device that can simulate the responses of multiple tags in an interrogation field as input to a reader under development or test.

### SUMMARY OF THE INVENTION

The present invention advantageously provides a method and system for analyzing and diagnosing radio frequency identification (“RFID”) systems. In accordance with one aspect, the present invention provides a radio frequency identification (“RFID”) analyzer for analyzing the performance of an RFID reader, in which the analyzer has an interface in communication with the reader. A processor is in communication with the interface. The processor operates to use the interface to at least one of monitor communication with the reader and simulate one or more RFID tags.

In accordance with another aspect, the present invention provides a method for analyzing the performance of an RFID reader in which there is communication with the reader via an interface. The interface is used to at least one of monitor communication with the reader and simulate one or more RFID tags

In accordance with still another aspect, the present invention provides a system for radio frequency identification (“RFID”) performance analysis. The system has an RFID reader and an RFID analyzer. The analyzer includes an interface in communication with the reader and a processor in communication with the interface. The processor operates to use the interface to at least one of monitor communication with the reader and simulate one or more RFID tags

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a system constructed in accordance with the principles of the present invention;

FIG. 2 is a block diagram of an RFID analyzer constructed in accordance with the principles of the present invention;

FIG. 3 is a block diagram of an alternate embodiment of a system constructed in accordance with the principles of the present invention; and

FIG. 4 is a block diagram of still another embodiment of a system constructed in accordance with the principles of the present invention.

### DETAILED DESCRIPTION OF THE INVENTION

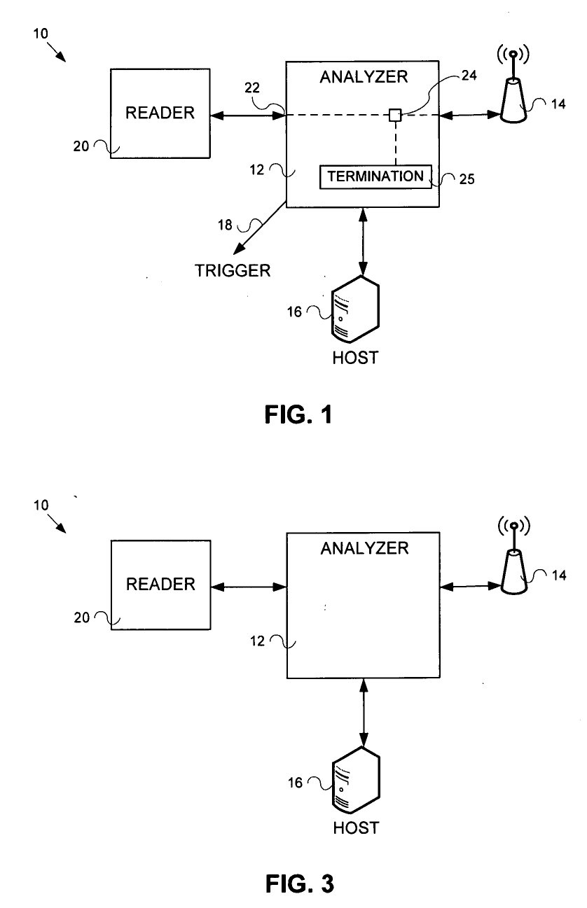

Referring now to the drawing figures in which like reference designators refer to like elements, there is shown in FIG. 1, an RFID analysis system constructed in accordance with the principles of the present invention and designated generally as “10”. System 10 includes RFID analyzer 12 and RFID antenna 14. Although FIG. 1 shows analyzer 12 externally coupled to RFID antenna 14 at an RF input, it is contemplated that antenna 14 can be integrated as part of analyzer 12. RFID antenna 14 is used to transmit and receive RFID backscatter signals to and from other RFID devices, such as tags (not shown), using an RFID air interface protocol, e.g., Electronic Product Code (“EPC”) Radio Frequency Identity Protocol gen 2.

System 10 can also optionally include host computer 16. Host computer 16 can be any computing device, such as a personal computer, laptop computer, personal digital assistant (“PDA”), mini-computer or mainframe computer, arranged to communicate with analyzer 12 to send and receive data, control information, etc. Host computer 16 can generate control information commands to control the operation of analyzer 12. Host computer 16 includes memory, CPU, I/O, display, etc., to track the communication with analyzer 12 in system 10. Host computer 16 can also store RFID data and commands decoded by analyzer 12. This can include decoding RFID data received from RFID tags within the interrogation zone of reader 20 or decoding RFID commands add data received from reader 20. Such storage can be in a volatile and/or non-volatile memory, such as an EEPROM. Communications between host 16 and analyzer 12 can be wireless or wired, e.g., USB, Ethernet, RS-232, RS-485, etc. Of course, analyzer 12 can include its own display and I/O devices (keypad, mouse, etc.) and sufficient storage to obviate the use of host 16 by performing the host functions itself.

Analyzer 12 also includes at least one trigger I/O interface 18 to allow an external device such as host 16, a oscilloscope or spectrum analyzer (not shown) to be triggered upon the detection of a specific event. By way of non-limiting example, trigger I/O interface 18 can be configured to send a signal to host 16 upon detection of a “QUERY” command, which is one of a series of commands used in a typical inventory round. By sending a trigger signal to host 16 each time this command is decoded, an oscilloscope can be triggered to begin data acquisition each time the “QUERY” command occurs. This advantageously allows detailed analysis of the RF waveforms at a specific point in the inventory round which is marked by the “QUERY” command.

RFID reader 20 is in communication with analyzer 12. Such communication can be a wired connection between an RF port 22 on analyzer 12 and reader 20 as shown in FIG. 1, or can be wireless such as using antenna 14 or another antenna (not shown) coupled to RF port 22 on analyzer 12. In the case of pass-through operation, switch 24 in analyzer 12 passes the signal received from antenna 14 to reader 20 (and vice versa). As is explained in detail below, even when in pass-through mode, analyzer 12 can decode the communication stream between reader 20 and other RFID devices, such as RFID tags.

Analyzer 12 can also be configured to operate as an RFID component, such as a tag. In this case there is no pass-through operation and switch 24 (which can be a physical or virtual switch) simply logically and physically originates/terminates the RFID signal at termination 25. Such may be useful, for example, when analyzer 12 is simulating multiple tags for testing the ability of reader 20 to “singulate” a tag from many tags in the interrogation field. The term “singulate” refers to the identification by an RFID of a tag with a specific serial number from a number of tags in its interrogation field.

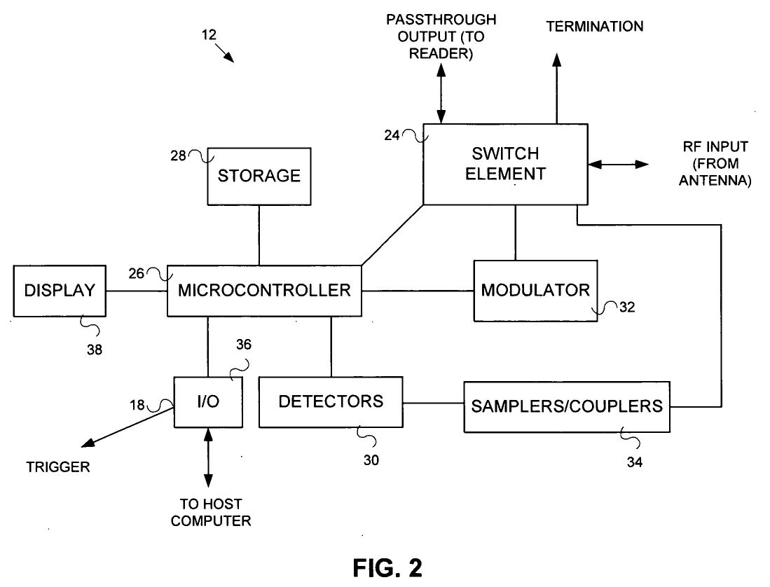

FIG. 2 is a block diagram of an RFID analyzer 12 constructed in accordance with the principles of the present invention. Analyzer 12 includes a central processing unit 26 such as a microcontroller or microprocessor used to control the operation of analyzer 12. Switch 24, storage unit 28, RF detectors 30, RF modulator 32, I/O ports 36 and peripheral devices (not shown), such as display 38, are in electrical communication with central processing unit 26. Samplers and couplers 34 that may be needed are in electrical communication with one or more of the detectors 30 and also with switch 24. In operation, analyzer operating code and data are stored in storage device 28 which can include volatile and/or non-volatile EEPROM storage areas for storing data. Modulator 32 is used to modulate a baseband signal onto an RF carrier for transmission via switch 24. Detectors 30 and samplers/couplers 34 operate together as a receiver to detect and extract the baseband signal and command and block data from a received RF signal, such as a signal complying with the EPC air interface standard. Switch 24 is controlled by microcontroller 26 to switch the input to termination 25 or pass-through to the reader 20. Switch 24 is also in communication with modulator 32 as well as with samplers/couplers 34.

As noted above, analyzer 12 includes I/O ports 36 taking the form of one or more types of interfaces and associated hardware and software to directly communicate with host computer 16 and/or provide trigger ports 18 to allow an external device such as host 16 to be triggered upon the detection of a specific event. Analyzer 12 can also optionally include display 38 and other peripheral devices (not shown) to allow self-contained usage of analyzer 12 without the use of host computer.

The present invention provides a diagnostic/lab tool in the form of an analyzer 12 that can decode the commands from an RFID reader, e.g., a reader that supports the EPC Class 1 Gen2 protocol, and then transmit the commands (like a code dis-assembler) to a host computer 16 via a communications link such as an Ethernet link or USB port, which in turn can record and log these commands. The system also provides digital outputs via trigger ports 18 to trigger other instruments like a scope or spectrum analyzer by transitioning one or more of these outputs whenever a certain command (or command+data), or other pattern in the reader interrogator data stream occurred. These monitoring and recording capabilities can be used when optimizing or troubleshooting field installations of RFID systems.

The system of the present invention can also respond as though it was a passive RFID tag, an active RFID tag or a population of RFID tags which allows the ability to stress test a reader and its capabilities as the number of tags in the interrogation field increases. By monitoring activity of the reader, the efficiency of tag singulation can be measured and analyzed, allowing for improvements to the reader's search algorithm.

For example, when analyzer 12 is configured to respond as though it was a passive RFID tag, analyzer 12 operates such that antenna 14 is positioned within an interrogation zone of reader 20 to induce an electrical current in antenna 14 by an incoming radio frequency signal. It is contemplated that the received power can be used to power a CMOS integrated circuit in central processing unit 26 to power up and transmit a response to reader 20. In other words, it is contemplated that analyzer 12 can be operated without an internal power source if configured to operate as a passive RFID tag. In this case, antenna 14 is designed to both collect power from an incoming signal and also to transmit an outbound backscatter signal by backscattering a carrier signal from reader 20. The response of analyzer 12 as a passive RFID tag can include, but is not limited to, a simulated ID number, simulated product information and other simulated information such as location of product in a warehouse. The omission of an onboard power supply for analyzer 12 if operating as a passive RFID allows for a physically compact device.

As another example, analyzer 12 can be configured to respond as if it is an active RFID tag. In this case, analyzer 12 includes a power supply which is used to power analyzer 12 to generate a backscatter signal and transmit the signal to reader 20. The response of analyzer 12 as an active RFID tag facilitates reliable operation with few errors due to the ability to conduct a communication “session” with reader 20. Because it is powered, analyzer 12 can transmit using higher and varying power levels, thereby and allowing analyzer 12 to test reader 20 and its capabilities as transmit power levels are varied. This also allows analyzer 12, behaving as a RFID tag, to aid overall system improvement in RF challenged environments like water or metallic, or at longer distances. By monitoring the activities of reader 20 at different power levels of backscatter signal, the efficiency of tag singulation can be measured and analyzed allowing for improvements to the search algorithm for reader 20 at each of the different power levels of the backscatter signal.

Analyzer 12 can also be configured to respond as though it is a plurality of active or passive RFID tags. When analyzer 12 is configured to respond as if it is simulating a plurality of RFID tags, it allows the ability to stress test reader 20 and the corresponding capabilities of reader 20 as the number of tags in the simulated interrogation field increases. For example, when analyzer 12 is simulating multiple tags, it can create a real-time interrogation field condition for different interrogation environments, such as a small, medium or large retail store or warehouse. This simulated interrogation environment allows system 10 to test the ability of reader 20 to “singulate” a tag from many tags in the interrogation field by identifying an RFID tag with a specific serial number from a population of other RFID tags in the same interrogation field. The simulated interrogation environment allows analyzer 12 to test the ability of reader 20 to receive RFID data from a large number of RFID tags as the number of tags in the interrogation field increases in a given time. In other words, analyzer 12 simulates the interrogation environment by simulating a plurality of RFID tags in a manner corresponding to the interrogation environment. For example, a large store might have a large interrogation zone with a large quantity of RFID tags, some of which are close to the reader and others of which are remote, while a small store might have a smaller interrogation zone with fewer RFID tags.

Based on these tests results, improvements to the search algorithm of reader 20 and/or correction of functionality of the reader 20, such as whether the reader 20 is working as desired or not, can be made. As mentioned previously, in this configuration, there is no pass-through operation between analyzer 12 and reader 20. Switch 24 originates/terminates the RFID signal and analyzer 12 operates as an RFID component to simulate one or more RFID tags.

An advantage of the present invention is that analyzer 12 can simulate an RFID tag as if the simulated RFID tag is in one of many possible real-time tag situations. For instance, a backscattered signal from a simulated RFID tag can be simulated as if the signal is reflected, refracted, or absorbed by object materials, such as building or packaging. Since an RFID tag may deliver varying performance depending upon its orientation and location upon or within a package, its distance from a reader and the frequency at which it operates, analyzer 12 can test the response of reader 20 to a simulated varying performance of an RFID tag. The testing ability of analyzer 12 of the present invention can prevent RFID system developers and purchaser from going through a trial and error process to purchase and evaluate RFID systems, which invariably leads to a time-consuming and costly process.

Analyzer 12 of the present invention also simulates the problem of complex object materials, changing object materials, and the wide variety of RFID tags available. For example, analyzer 12 can simulate an RFID tag in a particular operational environment as if the simulated RFID tag is placed upon a case containing a variety of objects which impacts the reception of the tag's antenna. Testing and analyzing the performance of reader 20 to the response of the simulated RFID tag that is placed upon a case containing a variety of objects is useful for improving the performance of reader 20.

Advantageously, the programmable nature of the analyzer 12 allows it to be field upgradable to support new air protocols and provide new analysis as well as new diagnostic capabilities and routines. For example, analyzer operating code and data are stored in storage device 28, such as an EEPROM, that can be programmed and erased electrically. Analyzer 12 can be reprogrammed to include a new test procedure by, for example, host 16.

FIG. 3 is a block diagram of an alternate embodiment of a system constructed in accordance with the principles of the present invention. In FIG. 3, analyzer 12 does not include switch element to switch the RF signal input to termination 25 or allow pass-through to the reader 20. Instead, host 16 serves as the origin/termination point for data corresponding to the RF signal and/or serves as the monitoring/storage device for data corresponding to the RF signal. In other words, in the embodiment shown in FIG. 3, analyzer 12 serves as a conduit through which host 16 provides the monitoring and analysis functions described above.

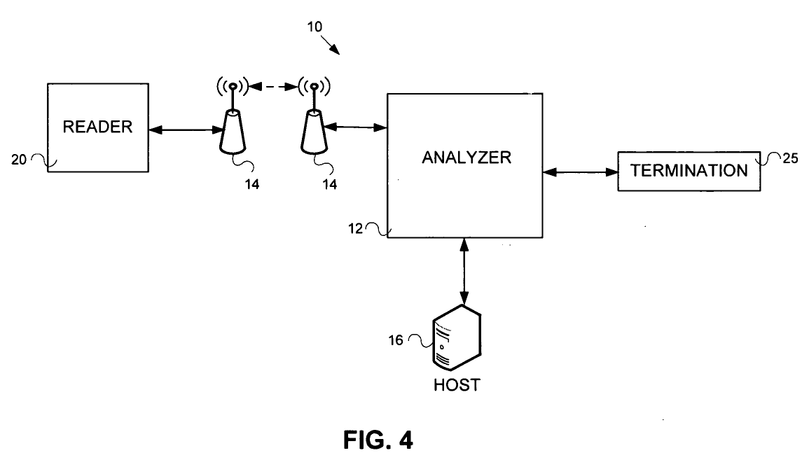

FIG. 4 is a block diagram of still another embodiment of a system constructed in accordance with the principles of the present invention. In the embodiment shown in FIG. 4, the communication between analyzer 12 and reader 20 can be performed via RF antenna 14. RF antenna 14 in this embodiment can be either a single or a dipole antenna. In one configuration, one antenna can be used for the communication between analyzer 12 and reader 20. In another configuration, more than one antenna can be used for communication between analyzer 12 and reader 20. System 10 also can be configured such that the termination 25 is external to analyzer 12. In this manner, the termination 25 can be used to control whether RFID analyzer 12 operates as an RFID component. For example, the presence of termination 25 allows analyzer 12 to operate as an RFID tag, while the omission of termination 25 allows analyzer 12 to operating in a pass-through and transparent monitoring mode as discussed above in detail.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A radio frequency identification (“RFID”) analyzer for analyzing the performance of an RFID reader, the analyzer comprising:
an interface in communication with the reader;
a processor in communication with the interface, the processor operating to use the interface to at least one of monitor communication with the reader and simulate one or more RFID tags.

2. The RFID analyzer according to claim 1, further comprising:
a receiver in communication with the processor, the receiver receiving an RFID backscatter signal and recovering a baseband signal there from, the baseband signal including received RFID data,
wherein the processor further operates to:
analyze the received RFID data; and
take an action based on the received RFID data.

3. The RFID analyzer according to claim 1, further comprising:
a modulator in communication with the processor, the modulator generating a transmit RFID signal including data corresponding to the one or more of simulated RFID tags.

4. The RFID analyzer according to claim 1, further including a switch in communication with the processor and the modulator, the switch operable to switch from a first position corresponding to a passthrough mode to support monitoring of the RFID signal to a second position corresponding to a termination mode to support RFID tag simulation.

5. The RFID analyzer according to claim 1, further including an I/O device in communication with the processor, the I/O device providing a triggering signal upon occurrence of a predetermined event.

6. The RFID analyzer according to claim 1, wherein the processor operates to simulate at least one passive RFID tag.

7. The RFID analyzer according to claim 1, wherein the RFID analyzer operates to simulate at least one active RFID tag.

8. A method for analyzing the performance of an RFID reader, the method comprising:
communicating with the reader via an interface;
using the interface to at least one of monitor communication with the reader and simulate one or more RFID tags.

9. The method according to claim 8, further comprising:
monitoring communication with the reader;
receiving an RFID backscatter signal;
recovering a baseband signal from the RFID backscatter signal, the baseband signal including received RFID data;
analyzing the received RFID data; and
taking an action based on the received RFID data.

10. The method according to claim 9, wherein taking an action includes generating a triggering signal.

11. The method according to claim 9, wherein simulating one or more RFID tags includes generating a transmit RFID signal, the RFID signal including data corresponding to the one or more of simulated RFID tags.

12. The method according to claim 8, further including switching from a passthrough mode to support monitoring of the RFID signal to a termination mode to support RFID tag simulation.

13. The method according to claim 8, further including providing a triggering signal upon occurrence of a predetermined event.

14. The method according to claim 8, wherein at least one passive RFID tag is simulated.

15. The method according to claim 8, wherein at least one active RFID tag is simulated.

16. A system for radio frequency identification (“RFID”) performance analysis, the system comprising:
an RFID reader; and
an RFID analyzer, the analyzer comprising:
an interface in communication with the reader;
a processor in communication with the interface, the processor operating to use the interface to at least one of monitor communication with the reader and simulate one or more RFID tags.

17. The system according to claim 16, wherein the RFID analyzer decodes monitored and received RFID data and commands, the system further comprising a host computer in communication with the RFID analyzer, the host computer storing the decoded RFID data and commands.

18. The system according to claim 17, wherein the analyzer further includes a trigger I/O interface in communication with the host, the storage of the decoded RFID data and commands being triggered by the trigger I/O interface based on the occurrence of a predetermined event.

19. The system according to claim 16, wherein the analyzer is arranged to simulate an interrogation environment, the analyzer simulating the interrogation environment by simulating a plurality of RFID tags in a manner corresponding to the interrogation environment.

20. The system according to claim 16, wherein the analyzer is arranged to simulate the one or more RFID tags in one or more operational environments.
